(19) United States
(12) Patent Application Publication
(10) Pub. No.: US 2021/0158372 A1
(43) Pub. Date: May 27, 2021

(54) SECURE MANAGEMENT OF OWNERSHIP OF PHYSICAL OBJECTS

(71) Applicant: International Business Machines Corporation, Armonk, NY (US)

(72) Inventors: Gero Dittmann, Zürich (CH); Jens Jelitto, Rueschlikon (CH)

(21) Appl. No.: 16/693,692

(22) Filed: Nov. 25, 2019

(51) Int. Cl. G06Q 30/00; G06Q 20/12; G06Q 30/06

(52) U.S. Cl. CPC G06Q 30/0185; G06Q 30/0635; G06Q 20/12

(57) ABSTRACT

A computer-implemented method, a computer system, and a computer program product for managing ownership of physical objects based on identifiers. A computer system provides an ownership database storing pairs of object identifiers and owner identifiers, and the ownership database is in data communication with a computerized transaction system. Upon the computerized transaction system triggering a transaction protocol for a transaction for a respective one of the physical objects, at the ownership database independently of the computerized transaction system, a process of transferring an ownership of the respective one of the physical objects is executed. In response to receiving a request to change the ownership from a buyer, the ownership database records a buyer identifier of the buyer as a new owner identifier associated with an object identifier of the respective one of the physical objects.

### BACKGROUND

The invention relates in general to the field of methods and techniques for managing and tracking ownerships of physical objects. In particular, it is directed to a method relying on an ownership database, which is updated independently of the computerized transaction system that controls the transaction processes.

There is an increasing need to track and trace ownerships of objects, in particular in a context of prevalent digital economy and transaction platforms. In such a context, it is needed to assure the authenticity of ownership transfers.

Distributed ledgers, in particular blockchains, have gained considerable attention as a technology that increases trust and visibility along the supply chain for more accurate tracing of goods as well as asserting whether a product is genuine or fake. Trust and controlled visibility are achieved in blockchain systems with cryptography, distributed protocols and privacy-enabling techniques, such as zero-knowledge or threshold-signature schemes. Complex manufacturing lines and supply chains can be securely monitored and documented such that downstream business processes can validate the provenance of an item. Likewise, upstream business processes can determine the recipients of goods, for instance in case of a product recall.

### SUMMARY

In one aspect, a computer-implemented method for managing ownership of physical objects based on identifiers is provided. The computer-implemented method includes providing an ownership database storing pairs of object identifiers and owner identifiers, wherein the owner identifiers identifies current owners of respective ones of physical objects corresponding to respective ones of the object identifiers, wherein the ownership database is in data communication with a computerized transaction system. The computer-implemented method further includes executing, at the ownership database independently of the computerized transaction system, a process of transferring an ownership of the respective one of the physical objects, upon the computerized transaction system triggering a transaction protocol for a transaction for a respective one of the physical objects. In the computer-implemented method, the process of transferring the ownership includes: receiving a request to change the ownership from a buyer; recording, in response to receiving the request, a buyer identifier of the buyer as a new owner identifier associated with an object identifier of the respective one of the physical objects.

According to the present method, it is the buyer who triggers the transfer of ownership by requesting it from the ownership database rather than from the transaction system. And even if the ownership transfer process is a consequence of the transaction system triggering the transaction protocol, it remains that the ownership transfer process is executed in response to the request from the buyer and based on data from the buyer (the buyer ID), i.e., independently of the transaction system. This, eventually, makes it possible to increase security of the ownership tracking mechanism as the buyer ID in the ownership request can be verified, e.g., against an ID of a user who paid for the object in question.

In preferred embodiments, the method further comprises receiving, at the ownership database and upon the transaction system triggering the transaction protocol, a notification as to an expected ownership change event in respect to the object, the notification comprising the object ID of the object.

Preferably, the notification received comprises a subscription to an ownership change event to be recorded at the ownership database in respect to the object. Accordingly, the ownership database notifies the computerized transaction system that the buyer ID of the buyer has been recorded as a new owner ID upon completion of the process of transfer of ownership, in response to the subscription. More preferably, the transaction system releases a payment for the transaction for the object upon receiving a notification from the ownership database that the buyer ID has been recorded as a new owner ID.

In embodiments, the method further comprises, at the computerized transaction system and prior to triggering the transaction protocol, interacting with the ownership database, upon request of a seller of the object, to verify a current ownership of this object based on its object ID and a seller ID of the seller.

In further embodiments, executing the process of transfer of ownership at the ownership database further comprises, on the one hand, forwarding the request received from the buyer to the seller, which request comprises the buyer ID and the object ID, and, on the other hand, receiving a confirmation from the seller that ownership can be changed, the confirmation comprising the buyer ID associated with the object ID, whereby the buyer ID of the buyer is subsequently recorded as a new owner ID.

In further embodiments, the method further comprises (at the transaction system and upon triggering the transaction protocol): listing object for sale; receiving, from the buyer, a purchase order for object; and communicating to the seller the object ID as well as data for shipping the object to the buyer.

In preferred embodiments, the ownership database is in data communication with a verification database, the latter storing pairs of the object IDs and digital fingerprints, or DFPs, of objects, and the request received is a request of the buyer having obtained a confirmation from the verification database of a genuineness of object based on a DFP derived from a physical fingerprint of the object.

Preferably, the method further comprises (at the buyer, and after the buyer has received the object) verifying that object is a genuine object by: obtaining DFP from the physical fingerprint, whereby the DFP obtained is impacted by a unique physical property of the object; and interacting with the verification database by sending a request comprising the object ID of the object and the DFP obtained.

Each object of the set preferably comprises a physical anchor having unique physical property, whereby the DFP is obtained from physical anchor, so as to be impacted by the unique physical property of the physical anchor of each object.

In preferred embodiments, verifying that the given object is a genuine object further comprises, with a same computerized device, detecting, on the one hand, the object ID and, on the other hand, the DFP, so as to obtain both the object ID and the DFP.

Preferably, the method further comprises (at the verification database): receiving from the buyer a request to confirm the genuineness of object, the request based on the object ID and the DFP detected by the buyer; and verifying whether this object ID and this DFP match one of the pairs of objects IDs and DFPs as stored on the verification database.

In embodiments, the method further comprises, prior to triggering the transaction protocol and for each object of a set of physical objects, a set of preparatory steps including: associating each object with an object ID; obtaining a DFP from a physical fingerprint of each object, the latter capturing a unique physical property of each object, whereby the DFP obtained is impacted by unique physical property; storing the object ID of each object and a corresponding owner ID on the ownership database, so as for the owner ID to be associated with object ID in the ownership database; and storing the object ID of each object and the DFP obtained on the verification database, so as for DFP to be associated with object ID.

Such preparatory steps are preferably performed as part of a commissioning of the set of physical objects. preparatory steps may possibly comprise pairing a physical anchor with each object, the physical anchor embodying physical fingerprint and thus having unique physical property, whereby the DFP obtained for each object is obtained from physical anchor.

In preferred embodiments, the preparatory steps are performed using a computerized system of a manufacturer of the physical objects and the ownership database is an external database in data communication with this computerized system.

In further embodiments, one or each of the ownership database and the verification database is supported by a distributed system and is configured as a shared ledger.

In another aspect, a computer system for managing ownership of physical objects based on identifiers is provided. The computer system comprises a communication interface for communicating with a computerized transaction system. The computer system further comprises one or more computer readable tangible storage devices storing pairs of object identifiers and owner identifiers, the owner identifiers identifying current owners of respective ones of physical objects corresponding to respective ones of the object identifiers. The computer system further comprises program instructions stored on at least one of the one or more computer readable tangible storage devices for execution by at least one of one or more processors, the program instructions executable to: execute, independently of the computerized transaction system, a process of transferring an ownership of the respective one of the physical objects, upon the computerized transaction system triggering a transaction protocol for a transaction for a respective one of the physical objects; record a buyer identifier of the buyer as a new owner identifier associated with an object identifier of the respective one of the physical objects, in response to receiving a request to change the ownership from a buyer.

Preferably, the computer system is a distributed system implementing the ownership database as a shared ledger.

In yet another aspect, a computer program product for managing ownership of physical objects based on identifiers is provided. The computer program product comprising one or more computer-readable tangible storage devices and program instructions stored on at least one of the one or more computer-readable tangible storage devices of a computer system. The program instructions are executable to, upon a computerized transaction system triggering a transaction protocol for a transaction for a respective one of the physical objects, execute, independently of the computerized transaction system, a process of transferring an ownership of the respective one of the physical objects. The program instructions are further executable to in response to receiving a request to change the ownership from a buyer, record a buyer identifier of the buyer as a new owner identifier associated with an object identifier of the respective one of the physical objects. The computer system supports an ownership database and the ownership database stores pairs of object identifiers and owner identifiers and the owner identifiers identify current owners of respective ones of physical objects corresponding to respective ones of the object identifiers. The computer system comprises a communication interface for communicating with the computerized transaction system.

Computer systems, methods, and computer program products embodying the present invention will now be described, by way of non-limiting examples, and in reference to the accompanying drawings.

### BRIEF DESCRIPTION OF THE SEVERAL VIEWS OF THE DRAWINGS

The accompanying figures, where like reference numerals refer to identical or functionally similar elements throughout the separate views, and which together with the detailed description below are incorporated in and form part of the present specification, serve to further illustrate various embodiments and to explain various principles and advantages all in accordance with the present invention.

The accompanying drawings show simplified representations of devices or parts thereof, as involved in embodiments. Similar or functionally similar elements in the figures have been allocated the same numeral references, unless otherwise indicated.

FIG. 1 depicts selected components and actors of a system that can be used to perform steps for managing ownerships of physical objects, in accordance with one embodiment of the present invention.

FIG. 2 schematically illustrates how a manufacturer may associate unique identifiers of physical objects with digital fingerprints obtained from unique physical properties of physical anchors affixed to the physical objects, in accordance with one embodiment of the present invention.

FIG. 3 and FIG. 4 are flowcharts for illustrating high-level steps of methods for managing ownerships of physical objects, in accordance with one embodiment of the present invention.

FIG. 5 schematically represents a computing system for implementing steps for supporting an ownership database, in accordance with one embodiment of the present invention.

### DETAILED DESCRIPTION

Typically, in prior art solutions for managing physical objects, an object is linked to a digital record by an object identifier (object ID), such as a unique identifier (UID), that represents either the individual object or a class of objects by model, batch, production site, manufacturer or similar. The UID is printed, embossed or attached as a tag to the object or its packaging. How can the object ID be associated with a person identifier to track, who corresponds to the legitimate owner? How can custody of the object be tracked, e.g., to track responsibility for high-value machinery that is being passed around within an organization? Willing to find responses to such questions, the present inventor developed solutions that can be made generic enough to support all sorts of objects from any vendor and many types of relationships between persons and objects.

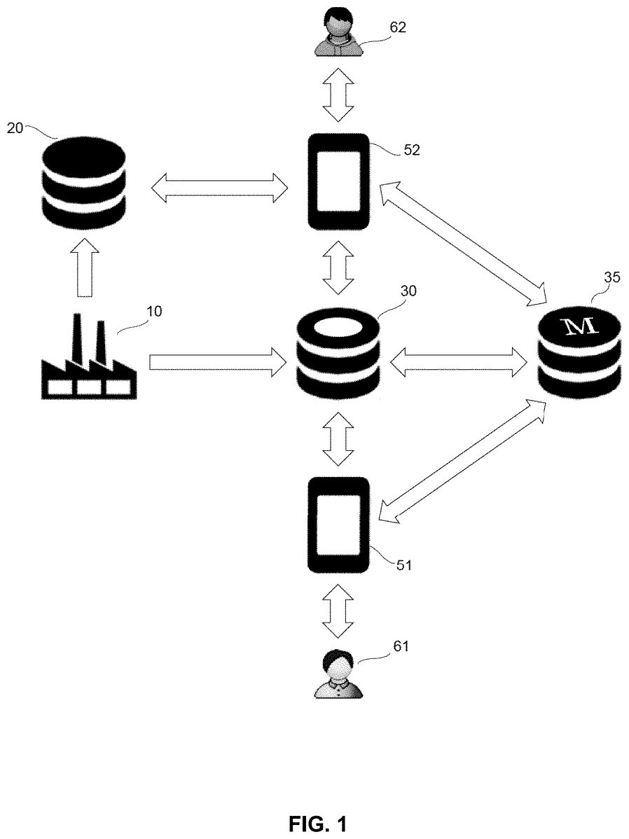

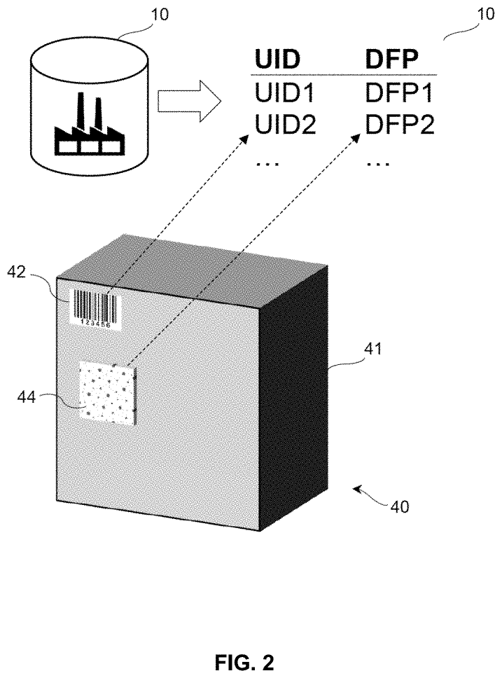

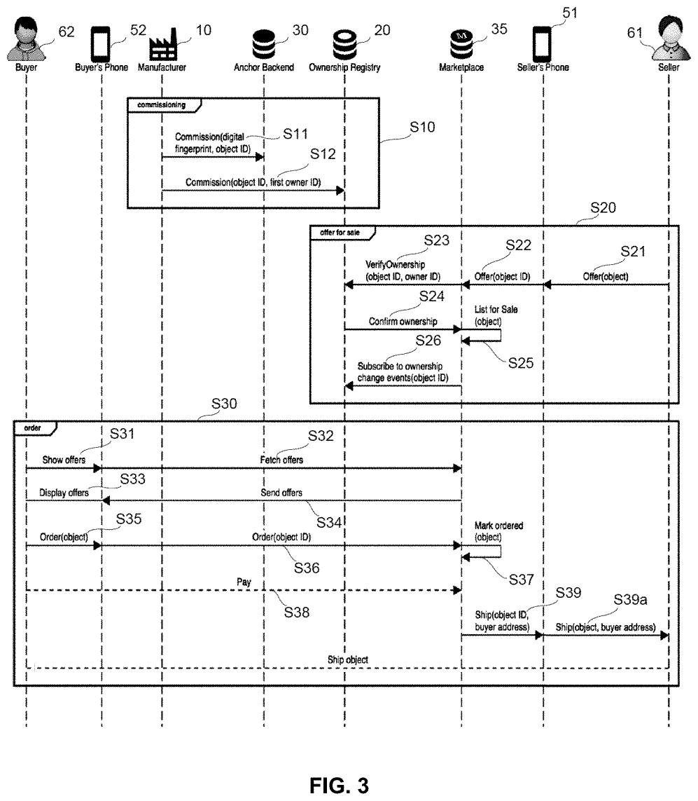

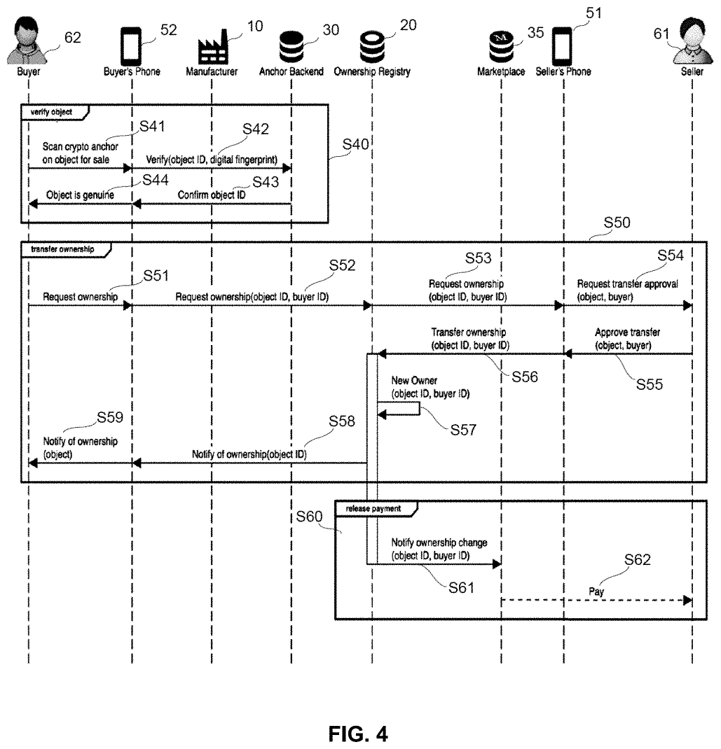

In reference to FIG. 1, FIG. 2, FIG. 3, and FIG. 4, an aspect of the invention is first described, which concerns a method for managing ownership of physical objects 40 based on identifiers (hereafter IDs). This method and its variants are collectively referred to as the “present methods” in this document.

The method relies on an ownership database 20 shown in FIG. 1, FIG. 3, and FIG. 4. The ownership database 20 stores pairs of object IDs and owner IDs. Such pairs involve associations between the object IDs and person IDs. The object IDs identify respective physical objects, while a respective one of owner IDs identifies a person who currently owns a respective one of the physical objects corresponding to the object IDs. In the database, an object ID typically indexes an owner ID, which implicitly establishes an association between the IDs at stakes. This association reflects a relationship (i.e., ownership) between the corresponding person and object. Additional parameters may be stored as well, if necessary.

The object ID is normally a unique object ID, or UID, allowing the object to be unambiguously identified. UIDs are assumed in the following. As usual, object IDs can for instance be encoded in linear or 2D barcodes stuck on respective objects or packages thereof.

The ownership database 20 is assumed to be in data communication with a computerized transaction system 35 shown in FIG. 1, FIG. 3, and FIG. 4. However, the ownership database 20 and the computerized transaction system 35 are distinct platforms. Plus, the amount of communication between the computerized transaction system 35 and the ownership database 20 is limited, e.g., to mere notifications, message exchanges, etc. That is, the computerized transaction system 35 cannot write to the ownership database 20. On the contrary, ownership transfers are recorded independently of the computerized transaction system 35, as explained below.

The ownership database 20 may execute a process S50 (shown in FIG. 4) of transfer of ownership for any object recorded therein. In terms of data written to the ownership database 20, this process is executed independently of the computerized transaction system 35, see steps S53-S57 in the flowchart of FIG. 4. In terms of causality, however, this process is started at the database 20 as a consequence of the computerized transaction system 35 triggering a transaction protocol S25 (shown in FIG. 3) and a third process S30 (shown in FIG. 3) for a transaction for this object, e.g., based on a notification or a subscription mechanism. However, in terms of timing, this process is effectively started and executed independently of the computerized transaction system 35.

Rather, the database will receive (at step S51 and S52 shown in FIG. 4) a request to change ownership of a given physical object from a buyer 62 (shown in FIG. 4). Then, in response to this request, the database records (at step S57 shown in FIG. 4) the buyer ID of the buyer 62 as a new owner ID associated with the object ID of the physical object. So, it is the buyer 62 who effectively triggers the ownership transfer process, even if this is a consequence of the transaction system 35 triggering a transaction protocol.

Note, a physical object as understood herein should be interpreted in a broad sense. It can be any item, substance, device, or even a system, and, more generally, a thing, that is, anything that has or can be associated with a unique physical property (e.g., by way of a physical anchor), wherein this property can be detected, deterministically. Note, human beings are evidently excluded.

Thus, the ownership database 20 is a database meant to keep track of owners. In the ownership database, each of the owner IDs is associated with a respective one of the object IDs. A second database, i.e., a verification database 30 shown in FIG. 1, FIG. 3, and FIG. 4, is preferably involved too, in addition to the ownership database 20, for reasons that will become apparent later. The two databases 20 and 30 may possibly be implemented in a same database (yet distinct from the system 35), where each of the two databases includes a subset of entries of the overall database. In preferred variants, however, the two databases are implemented as fully distinct databases, which are more preferably supported by distinct physical systems. Note, however, that each of the two databases can advantageously be implemented as blockchains.

The transaction system 35 will typically be implemented as an online platform, in data communication with the ownership database. This way the transaction system 35 and the ownership database 20 may exchange useful messages, and notify each other, etc., although the transaction system 35 cannot write into the ownership database and does not determine which data is written to the database 20, for security reasons. Again, the process of transfer of ownership is executed independently of the transaction system 35, such that the database 20 is updated independently of the transaction system 35.

Still, upon request of a seller to sell an object, the transaction system 35 may for example first verify the current ownership status of the object by interacting with the ownership database 20. The ownership database 20 will typically confirm the current ownership of this object by returning the corresponding owner ID and only then will the transaction system 35 trigger the transaction protocol. Similarly, the transaction system 35 may then notify the database 20 that a transaction is taking place. Then, the ownership database may notify the transaction system that an ownership transfer took place, e.g., for the transaction system to release a payment, as in embodiments discussed below.

The transaction system can be regarded as a virtual marketplace, which coordinates all entities involved, i.e., the seller 61 (shown in FIG. 1, FIG. 3, and FIG. 4), the buyer 62, and the databases 20 and 30, at least until the buyer 62 requests the change of ownership. Eventually, the ownership database executes the process of transfer of ownership, to associate the buyer ID (as a new current owner ID) with the object ID, in response to a request from the buyer.

According to the present method, this is the buyer 62 who ultimately triggers the transfer of ownership by requesting it from (or of) the ownership database 20 rather than from (or of) the transaction system 35. The ownership database is requested by the buyer to proceed to the transfer of ownership. Even if the ownership transfer is a consequence of the transaction system 35 triggering the transaction protocol, it remains that the ownership transfer process is executed in response to the request from the buyer and based on data from the buyer (the buyer ID), i.e., independently of any data the transaction system 35 may provide. This, eventually, makes it possible to increase security of the ownership tracking mechanism as the buyer ID in the ownership request can be verified, e.g., against an ID of a user who paid for the object in question.

All this is now described in detail, in reference to particular embodiments of the invention, which rely on optional features of the invention. All references “Sij” refer the methods steps depicted in the flowcharts of FIGS. 3 and 4.

To start with, and as illustrated in FIG. 3, the ownership database 20 may receive (at step S26), upon the transaction system 35 triggering (at step S25) the transaction protocol, a notification as to an expected ownership change event in respect to object. This notification comprises the object ID corresponding to the object at stake. This notification may amount to a subscription to an ownership change event in respect of object, as discussed below.

Optionally, the ownership database 20 may further store access right parameters for respective ones of the object IDs, wherein the parameters determine permissions to change owner IDs associated with object IDs. Thus, upon receiving (at step S26) the notification, the ownership database 20 may accordingly update (at step S26) one of the parameters that is associated with the object ID of object. This way, ownership cannot be changed unless the transaction system has informed, beforehand, that ownership may indeed happen to change (for legitimate reasons, because a transaction is happening). That is, upon updating this parameter, the ownership database readies itself for an ownership change. Subsequently, the buyer requests (see steps S51 and S52 shown in FIG. 4) the ownership database to change ownership. A malicious request, however, would be rejected if the transaction system 35 would not have notified the anticipated change beforehand, which results in improving security of the process. Note, the execution of the process of transfer of ownership at the ownership database nevertheless remains independent of the transaction system, from the moment the system has notified (at step S26) the ownership database of the anticipated change.

As noted above, the notification received (at step S26) may possibly comprise a subscription to an ownership change event to be recorded at the ownership database 20 in respect to the object. In turn, the ownership database 20 may, in response to the subscription, subsequently notify (at step S61 shown in FIG. 4) the computerized transaction system 35 that the buyer ID of the buyer 62 has been recorded (at step S57 shown in FIG. 4) as a new owner ID, i.e., upon completion of the process S50 (shown in FIG. 4) of transfer of ownership.

By subscribing to an ownership change event at the ownership database 20 in respect of any given object, the transaction system 35 requests to be informed of a subsequent recording of ownership change, which will prompt the transaction system 35 to take due action with respect to the seller, e.g., release a payment. For example, upon receiving a notification at step S61 (shown in FIG. 4) from the ownership database 20 that the buyer ID has indeed been recorded (at step S57 shown in FIG. 4) as a new owner ID, the transaction system 35 may release a payment for the transaction for the object.

In variants, the ownership database 20 may simply notify (at step S61 shown in FIG. 4) the transaction system 35 that ownership has been transferred (e.g., upon recording the buyer ID of the buyer as a new owner ID) and irrespective of any previous subscription request. The notification performed at step S61 (shown in FIG. 4) may be systematically done, even if the transaction system 35 has not subscribed to this notification.

Referring back to FIG. 3, the ownership database 20 may advantageously interact (at step S23 and step S24) with the computerized transaction system 35, prior to the computerized transaction system triggering a transaction protocol for any object of interest. Namely, upon receiving a request (at step S21 and step S22) of a seller 61 willing to offer a given object for sale, the computerized transaction system 35 may interact (at step S23 and step S24) with the database 20, in order to verify a current ownership of this object based on the corresponding object ID and a seller ID of the seller. In turn, the transaction system 35 lists (at step S25) the object for sale only if the database 20 confirms (at step S24) the current ownership by the requesting seller 61. If not, then the transaction system 35 will normally not accept this object for sale.

As illustrated in FIG. 4, the execution of the ownership transfer process (at the ownership database 20) may further comprise forwarding (at step S53 and step S54) the request received from the buyer 62 to the seller 61. This request comprises the buyer ID and the object ID. The database 20 may subsequently receive (at step S56) a confirmation from the seller 61 that ownership can indeed be changed. This confirmation comprises the buyer ID associated with the object ID. Once confirmed this way, the buyer ID of the buyer 62 can subsequently be recorded (at step S57) as a new owner ID at the database 20.

A preferred transaction protocol is now described in detail, in reference to FIG. 3. As noted earlier, the transaction system 35 may, upon triggering the transaction protocol, list (at step S25 shown in FIG. 3) an object for sale. Then, when receiving (at step S36 shown in FIG. 3) from a buyer 62 a purchase order for the object, the transaction system 35 communicates (at step S39 shown in FIG. 3) the object ID, as well as data for shipping the object to the buyer 62, with the seller 61. This scheme has advantages in terms of privacy, inasmuch as the buyer 62 does not need to directly interact with the seller and, conversely, the seller 61 does not need to know the identity of the buyer, since shipment data provided to the seller may be anonymous. Once shipment data have been sent (at step S39a shown in FIG. 3) to the seller 61, the seller 61 may effectively ship the product to the buyer 62.

In embodiments, the ownership database 20 is further in data communication with a second database, i.e., a verification database 30, which stores pairs of object IDs and digital fingerprints (DFPs) of the objects. The verification database 30 is typically implemented as a back-end system maintaining relationships between object IDs and DFPs. Each of the DFPs is associated with a respective one of the object IDs. The verification database 30 can advantageously be accessed by a buyer 62 prior to requesting a change of ownership, to verify the genuineness of this object, as discussed below.

Namely, once the buyer 62 has effectively received the object, the buyer 62 may verify (in process S40 shown in FIG. 4) that this object is a genuine object by obtaining (at step S41 shown in FIG. 4) a DFP from a physical fingerprint of the object as shipped. The DFP obtained (at step S41) by the buyer 62 is accordingly impacted by a unique physical property of this object, which makes it possible to achieve a tight link between the physical object and its digital representation. That is, the physical object is tied to its associated digital record, hence the benefit of relying on digital fingerprints, in addition to object IDs.

The DFP is typically a number, a string, or any combination of characters (possibly including digits and other characters), or, more generally, a dataset that reflects the unique property (or a unique set of properties). Such a physical property should be understood in a broad sense, as it may include a mechanical, optical, electrical, or even a chemical or biological property of this object, or combinations thereof. It may for example stem from a physical fingerprint (such as a surface structure) or embedded security features (as in banknotes). This property may notably be provided by a physical anchor 44, added on purpose to the object 40 (shown in FIG. 2), as discussed later. In all cases, the DFPs are, each, impacted by a unique physical property of a respective object.

After having obtained (at step S41) a DFP for a given object, the buyer 62 interacts (at step S42 and step S43) with the verification database 30. In detail, the buyer 62 sends (at step S42) a request comprising the object ID of the object and the DFP obtained at step S41. Upon receiving this request, the database 30 verifies whether this object ID and this DFP match one of the pairs of objects IDs and DFPs as stored thereon. If a match is found, the database 20 sends (at step S43 and step S44) a confirmation to the user 62, via the user device 52, indicating that the object is indeed a genuine object. On the contrary, a standard error message would be sent if no match were found, e.g., inviting the buyer to retry and rescan the DFP, for example.

Thus, the request received at step S52 by the ownership database 20 will preferably be a request of the buyer 62 having already obtained (in process S40) a confirmation (at step S43) of the genuineness of the object from the verification database 30, based on (at step S42) the DFP derived (at step S41) from the physical fingerprint of the object.

The above scheme allows the buyer 62 to verify the genuineness of the object (again independently of the transaction system 35), prior to requesting to update the ownership status attached to the object. This verification involves digital fingerprints, which do not need to be handled through the transaction system 35, for security reasons. Genuineness of the object is confirmed before triggering the transfer of ownership, thanks to interactions between the buyer and the verification database 30, which can be maintained independently of each of the transaction system 35 and the ownership database 20. The transaction system 35 is preferably not in data communication with the verification database 30, again for security reasons. In variants, the transaction system may nevertheless be notified by the database 30 and record a confirmation that the object is genuine, though this is not strictly necessary.

Preferably, at least some of the objects 40 comprise, each, a physical anchor 44, which is designed so as to exhibit the unique physical property, as illustrated in FIG. 2. In that case, the DFP obtained at step S41 is impacted by the unique physical property of the physical anchor 44 of the object 40. A physical anchor 44 may for example be unalterably affixed to (entangled with) the object, e.g., with a strong adhesive or in a way that irrevocably alter the exploited property, the object 40 itself, or a main functionality thereof, when removed, destroyed, or otherwise altered. The anchor 40 may also be integrated, in an inalterable way, in a body of the object. Anchors may for example include embedded security features (e.g., microprinting, security ink, or hologram), and/or physical fingerprints (e.g., a physical unclonable function).

Note, the physical anchor can be affixed to a product or an item, or its packaging (which itself is or comprises an object). The trust-anchor is established for the object bearing the physical anchor. Thus, protection is achieved for the actual object whose unique physical property is exploited. Accordingly, the physical property is preferably extracted from a physical anchor that is tied to the product or item to be sold, rather than its packaging.

In variants to physical anchors, which are specific objects provided on purpose, one or more physical properties of the primary object 40 itself may be exploited, such as a surface state, a precise weight, etc., without it being needed to explicitly attach a physical anchor to the object. Physical anchors, however, will normally make it easier to achieve unique physical properties, in a more systematic and controllable way. Still, inherent physical anchors (which can normally not be controlled) would inherently provide a larger degree of entropy, which make them more difficult to clone. In contrast, physical anchors provided on purpose are, in principle, easier to attack precisely because they are more controllable and systematic. Thus, the uniqueness of explicit physical anchors must be generated with some effort.

As illustrated in FIG. 1, FIG. 3, and FIG. 4, interactions with the participants 61 and 62 are preferably achieved using user devices 51 and 52. For instance, the user device 52 may be configured to perform the detection at step S41 itself, for practical reasons. The user device 52 is thus preferably used to detect at step S41 the DFP from the physical fingerprint of the object, as assumed in the flowchart of FIG. 3. In variants, the DFP detection is performed via another device in data communication with the user device 52, such that the latter can still be used to perform (e.g., initiate) the verification process by passing relevant data (object ID and corresponding DFP) to the verification database 30.

Similarly, the user device 52 may possibly be configured to perform the detection of the object ID, e.g., based on a barcode 42 paired to the object, see FIG. 2. Thus, the user device 52 is preferably used to detect (at step S41) the object ID as well. Accordingly, a same computerized device 52 may be used for detecting (at step S41) both the object ID and the corresponding DFP, as well as for initiating the verification process S40 and requesting process S50 the transfer of ownership. For example, the verification process S40 may comprise detecting (at step S41) both the object ID and the DFP using the same computerized device 52, and the confirmation received at step S43 (as per interactions at steps S42 and S43 with the verification database 30) may be received on that same computerized device 52. This way, a number of method steps are efficiently coordinated through the same device 52 (the buyer's device).

All this may for example by carried out thanks to a suitably configured device 52, e.g., a smartphone or a tablet with a suitable application installed thereon. In variants, an optical device may also be used along with dedicated software, e.g., applying computer vision and image processing techniques to glean information digitally by optically scanning the object 40 (or the physical anchor 44 thereof), and the barcode 42 paired to it, as assumed in the example of FIG. 2.

Referring back to FIG. 3, the present methods preferably comprise a set of preparatory steps in an initial process S10, which are performed for each object of a set of physical objects 40. Such steps are performed during the initial process S10, prior to triggering any transaction protocol for any such objects.

These steps essentially consist in associating a respective one of objects with an object ID, obtaining a DFP for the respective one of the objects, and exporting (at steps S11 and S12) the data accordingly obtained to the relevant databases 20 and 30. Again, the DFPs are obtained from physical fingerprints of the objects. On the one hand, object IDs and corresponding owner IDs (if already known) are exported (at step S12) to and stored on the ownership database 20, so as for the owner IDs to be associated with respective object IDs in the ownership database 20. On the other hand, object IDs and DFPs are exported to and stored (at step S11) on the verification database 30, so as for DFPs to be associated with the object IDs.

The above process S10 may for example be implemented by the manufacturer of the objects 40, as assumed in FIG. 2, which further depicts DFPs being paired with corresponding UIDs at the manufacturer back-end system. Process S10 preferably include pairing physical anchors (embodying the physical fingerprints and thus having the unique physical properties) with respective objects, prior to obtaining the DFPs. This can be done at the manufacturer site too. In turn, the manufacturer may associate UIDs with DFPs prior to exporting them, as illustrated in FIG. 2.

This allows, later on, the buyer 62 that has received a given object to verify whether this object is genuine, by interacting with the verification database 30. Then, this buyer 62 may request a transfer of ownership directly at the ownership database 20 (i.e., the request is sent to the ownership database). The ownership database 20 will then forward all necessary data to the seller 61 for her/him to approve the request, such that the ownership database 20 may eventually record the change of ownership, as in embodiments described herein. The same steps can then be repeated as long as necessary to perform further transactions, which makes it possible to securely track ownerships.

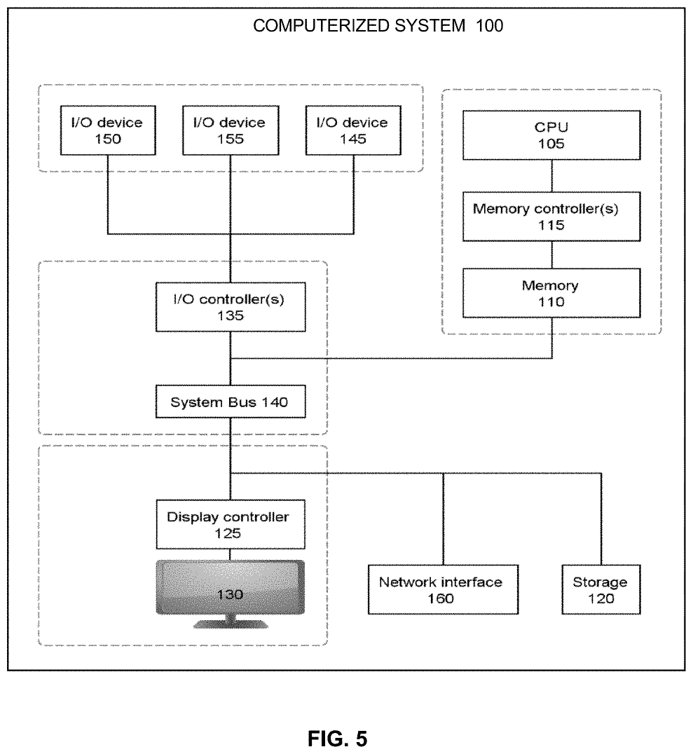

The above preparatory steps included in the process S10 are preferably performed as part of a commissioning process S10 of the physical objects 40, as assumed in the following. In the present context, commissioning objects means readying the objects for their lifecycle management. The commissioning step can also be regarded as a set of preparatory steps to bring the objects into working condition or market such objects. Typically, batches of numerous, similar objects need be commissioned at the same time by manufacturers. Thus, the commissioning process typically deals with sets of objects. The commissioning process is preferably performed by a trusted entity, typically the manufacturer 10 or an initial legal owner of the objects, or under control of this owner or the manufacturer, preferably at the manufacturer's site, e.g., by a trusted back-end system at the manufacturer's site. The back-end system will typically involve one or more computerized units such as depicted in FIG. 5. So do the databases 20 and 30.

Cryptographic signatures from the manufacturer 10 are likely involved at some point. For example, a signature can be verified prior to download an application running on the user devices 51 and 52. That is, the present methods may further comprise downloading, installing, and executing a program on the user devices 51 and 52, during a preliminary phase. Executing this program will cause to suitably configure the user devices 52 for them to be able to interact with each of databases 20 and 30. T he same application program may for instance be downloaded and executed on the user devices 51 and 52 of all participants 61 and 62. In variants, the DFPs as stored on the second database 30 may be signed and the DFPs verified at the user device 52 prior to request a transfer of ownership, for example. Any public key infrastructure (PKI) may be involved.

At least one of the databases 20 and 30 may possibly be a distributed system, preferably configured as a shared ledger. The shared ledger may notably be configured as a blockchain, and more preferably as a business blockchain such as the so-called Hyperledger Fabric, or a similar blockchain relying on a consensus algorithm that is less compute-intensive than the so-called Proof-of-Work variant.

Various scenarios can be contemplated. In a first scenario, the database 30 is a trusted backend and the ownership database 20 is configured as a shared ledger. Because the verification database 30 (called anchor backend in FIG. 3 and FIG. 4) is a trusted backend, it is trusted that the physical identities of objects cannot be forged. Since the first database 20 is a shared ledger, the transactions recorded in the ledger cannot be forged either. In variants, each of databases 20 and 30 is implemented as a shared ledger, e.g., a blockchain whose integrity is ensured by smart contracts and other security mechanisms characteristic of a blockchain. Thus, each of databases 20 and 30 can either be a database controlled and protected by a trusted entity (e.g., by the manufacturer) and, therefore, trusted, or a shared ledger. In other variants, the two databases can be combined in one system, as noted earlier.

A blockchain is an attractive back-end platform in the present context as it is distributed, immutable, can be highly available and can, if suitably set up, be independent of object manufacturers and vendors. In variants to blockchains, a central database may be used. However, a central database might be subject to attacks and a single point of failure, not least if the manufacturer goes out of business. Thus, relationships transactions can advantageously be stored on a blockchain, where distribution and consensus algorithms improve the robustness against failure and fraud.

The above embodiments have been succinctly described in reference to the accompanying drawings and may accommodate a number of variants. Several combinations of the above features may be contemplated. For instance, the flowchart of FIG. 3 and FIG. 4 involve the following scenario.

First, the back-end system of a manufacturer 10 of objects assigns UIDs. Physical anchors are affixed to objects 40 and corresponding DFPs are detected, for the back-end system of the manufacturer 10 to pair UIDs and corresponding DFPs (see FIG. 2). Then the back-end system of the manufacturer 10 exports, on the one hand, pairs of UIDs and DFPs to the verification database (anchor backend) 30 and, on the other hand, pairs of UIDs and owner IDs (which initially may be the ID of the manufacturer, or of a retailer, if already known) to the ownership database (registry) 20, during a commissioning process S10.

During a second process S20, a given seller 61 offers (at step S21) a given one (or several) of the objects for sale, by interacting with an application already installed on her/his device 51. This application contacts the transaction system (marketplace) 35 and communicates (at step S22) the relevant UIDs. The transaction system 35 then interacts (at step S23 and step S24) with the ownership database 20 to verify the current ownership status of the object at issue. Upon the ownership database 20 confirming, the transaction system 35 lists (at step S25) this object for sale, amongst other objects, and contacts (at step S26) the ownership database to subscribe to ownership change events.

Then during a third process S30, a buyer 62 browses (step S31-step S33) the current offers, using a device 52 connected (at step S32) to the transaction system 35. The user 62 may thus come to select one item and order (at step S35) it, which causes the application (as already installed on her/his device 52) to communicate (at step S36) a corresponding UID to the transaction system 35, which accordingly flags (at step S37) this objects as being ordered. The buyer may then proceed (at step S38) to payment (to the system 35). In response, the transaction system 35 sends (at step S39) the UID and shipment data to the seller device 51. Reading (at step S39a ) this notification, the seller will then ship the item.

Next, during a fourth process S40, the buyer, who has now received the object, scans (at step S41) the DFP and the UID of the object (in variants, the UID may be selected from a menu in the application, which will automatically prompt the buyer to scan the DFP, for example). Corresponding data is then sent to the verification database 30, for the verification database 30 to confirm (steps S42-S44) the genuineness of the object.

Ownership can then be transferred, during a fifth process S50. A corresponding request is initiated at step S51 by the buyer 62, which request is forwarded (at step S52) by the device 52 to the ownership database 20, and from there forwarded (at step S53) to the device 51, in order to obtain (steps S54-S55) approval of the seller 61. Upon receiving (at step S56) an approval instruction from the device 51, the ownership database 20 registers (at step S57) the buyer 62 as a new owner, and accordingly notifies (steps S58-S59) the buyer 62.

Step S57 further triggers a notification (step S61) to the transaction system 35 that ownership has been changed (in response to the previous subscription request), for the transaction system 35 to release (at step S62) the payment, during a sixth and last process S60.

Many variants to the above scheme can be contemplated, in particular in contexts where ownership changes are not conditioned by payments. Note, the above phases may be partly concomitant.

Referring to FIG. 5, another aspect of the invention is now described, which concerns a computerized system 100 supporting an ownership database 20 for managing ownership of physical objects 40. Functional aspects of such a system have already been described in reference to the present methods. Such a system is thus only succinctly described in the following.

Essentially, the system comprises a communication interface, storage means, and processing means. The communication interface is designed for communicating with a computerized transaction system 35 as described earlier, e.g., an on-line platform. The storage means 110 notably stores instructions, and pairs of object IDs and owner IDs, as described earlier. The processing means 105 are configured to execute the instructions, so as to execute steps S53-S57 in a process S50 of transfer of ownership. More details as to such a system are given in previous paragraphs.

As explained earlier, the process S50 is executed upon (i.e., as a consequence of) the computerized transaction system 35 triggering a transaction protocol S25 and S30 for a transaction for an object. The process S50 of transfer of ownership is otherwise executed independently of the computerized transaction system 35, in terms of data written to the database 20. In terms of timing, this process is triggered upon receiving (steps S51 and S52) a request to change ownership of the object from the buyer 62. Eventually, this process leads to store (step S57) a buyer ID of the buyer 62 as a new owner ID on the storage means, whereby the new owner ID is now associated with the object ID.

Because the system 100 comes to interact with other computerized entities 30 and 35, instructions executed by the processing means 105 may for instance be executed jointly with other instructions at other computerized entities (e.g., similar to 100) by processing means of the entities, as necessary to perform such steps, in operation.

In embodiments, the computerized system is a distributed system implementing the ownership database 20 as a shared ledger, e.g., a business blockchain, as discussed earlier.

Next, according to a final aspect, the invention can also be embodied as a computer program product for managing ownership of physical objects 40. The computer program product comprises a computer readable storage medium having program instructions embodied therewith. The program instructions are executable by one or more processors of a computerized system such as described above, supporting an ownership database 20. The computerized system is assumed to be in data communication with a computerized transaction system 35, in operation. The program instructions are executable to cause the computerized system to execute S53-S57 in a process S50 of transfer of ownership as described earlier in reference to the present methods. Additional details relating to such computer program products are given in latter paragraphs.

Computerized devices can be suitably designed for implementing embodiments of the present invention as described herein. For instance, the computerized system 100 depicted in FIG. 5 schematically represents a general-purpose computer. In exemplary embodiments, in terms of hardware architecture, as shown in FIG. 5, the computerized system 100 includes a processor 105, memory 110 coupled to a memory controller 115, and one or more input and/or output (I/O) devices 145, 150, and 155 (or peripherals) that are communicatively coupled via a local input/output controller 135. The input/output controller 135 can be, but is not limited to, one or more buses or other wired or wireless connections, as is known in the art. The input/output controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 105 is a hardware device for executing software, particularly that stored in memory 110. The processor 105 can be any custom made or commercially available processor, a central processing unit (CPU), an auxiliary processor among several processors associated with the computerized system 100, a semiconductor-based microprocessor (in the form of a microchip or chip set), or generally any device for executing software instructions.

The memory 110 can include any one or combination of volatile memory elements (e.g., random access memory) and nonvolatile memory elements. Moreover, the memory 110 may incorporate electronic, magnetic, optical, and/or other types of storage media. Note that the memory 110 can have a distributed architecture, where various components are situated remote from one another, but can be accessed by the processor 105.

The software in memory 110 may include one or more separate programs, each of which comprises an ordered listing of executable instructions for implementing logical functions. In the example of FIG. 4, the software in the memory 110 includes methods described herein in accordance with exemplary embodiments and a suitable operating system (OS) 111. The OS 111 essentially controls the execution of other computer programs and provides scheduling, input-output control, file and data management, memory management, and communication control and related services.

The methods described herein may be in the form of a source program, executable program (object code), script, or any other entity comprising a set of instructions to be performed. When in a source program form, then the program needs to be translated via a compiler, assembler, interpreter, or the like, as known per se, which may or may not be included within the memory 110, so as to operate properly in connection with the OS 111. Furthermore, the methods can be written as an object-oriented programming language, which has classes of data and methods, or a procedure programming language, which has routines, subroutines, and/or functions.

Possibly, a conventional keyboard 150 and mouse 155 can be coupled to the input/output controller 135. Other I/O devices 145, 150, and 155 may include other hardware devices.

In addition, the I/O devices 145, 150, and 155 may further include devices that communicate both inputs and outputs. The computerized system 100 can further include a display controller 125 coupled to a display 130. In exemplary embodiments, the computerized system 100 can further include a network interface or transceiver 160 for coupling to a network. The network transmits and receives data between the computerized system 100 and external systems. The network is possibly implemented in a wireless fashion, e.g., using wireless protocols and technologies, such as WiFi, WiMax, etc. The network may be a fixed wireless network, a wireless local area network (LAN), a wireless wide area network (WAN) a personal area network (PAN), a virtual private network (VPN), intranet or other suitable network system and includes equipment for receiving and transmitting signals.

The network can also be an IP-based network for communication between the computerized system 100 and any external server, client and the like via a broadband connection. In exemplary embodiments, network can be a managed IP network administered by a service provider. Besides, the network can be a packet-switched network such as a LAN, WAN, Internet network, etc.

If the computerized system 100 is a PC, workstation, intelligent device or the like, the software in the memory 110 may further include a basic input output system (BIOS). The BIOS is stored in ROM so that the BIOS can be executed when the computerized system 100 is activated.

When the computerized system 100 is in operation, the processor 105 is configured to execute software stored within the memory 110, to communicate data to and from the memory 110, and to generally control operations of the computerized system 100 pursuant to the software. The methods described herein and the OS 111, in whole or in part are read by the processor 105, typically buffered within the processor 105, and then executed. When the methods described herein are implemented in software, the methods can be stored on any computer readable medium, such as storage 120, for use by or in connection with any computer related system or method.

While the present invention has been described with reference to a limited number of embodiments, variants and the accompanying drawings, it will be understood by those skilled in the art that various changes may be made and equivalents may be substituted without departing from the scope of the present invention. In particular, a feature (device-like or method-like) recited in a given embodiment, variant or shown in a drawing may be combined with or replace another feature in another embodiment, variant or drawing, without departing from the scope of the present invention. Various combinations of the features described in respect of any of the above embodiments or variants may accordingly be contemplated, that remain within the scope of the appended claims. In addition, many minor modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims. In addition, many other variants than explicitly touched above can be contemplated.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the C programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for managing ownership of physical objects based on identifiers, the computer-implemented method comprising:
providing an ownership database storing pairs of object identifiers and owner identifiers, the owner identifiers identifying current owners of respective ones of physical objects corresponding to respective ones of the object identifiers, wherein the ownership database is in data communication with a computerized transaction system;
upon the computerized transaction system triggering a transaction protocol for a transaction for a respective one of the physical objects, executing, at the ownership database independently of the computerized transaction system, a process of transferring an ownership of the respective one of the physical objects; and
wherein the process of transferring the ownership comprising:
receiving a request to change the ownership from a buyer; and
recording, in response to receiving the request, a buyer identifier of the buyer as a new owner identifier associated with an object identifier of the respective one of the physical objects.

2. The computer-implemented method of claim 1, further comprising:
receiving, upon the computerized transaction system triggering the transaction protocol, a notification as to an expected ownership change event in respect to the respective one of the physical objects, the notification comprising the object identifier of the respective one of the physical objects.

3. The computer-implemented method of claim 2, wherein the notification comprises a subscription to the expected ownership change event to be recorded at the ownership database, and the method further comprises:
at the ownership database, notifying the computerized transaction system that the buyer identifier has been recorded as the new owner identifier upon completion of the process of the process of transferring the ownership, in response to the subscription.

4. The computer-implemented method of claim 3, further comprising:
at the transaction system, upon receiving the notification from the ownership database, releasing a payment for a transaction for the respective one of the physical objects.

5. The computer-implemented method of claim 1, further comprising:
at the computerized transaction system and prior to triggering the transaction protocol, interacting, upon a request of a seller of the respective one of the physical objects, with the ownership database to verify a current ownership of the respective one of the physical objects based on object identifier and a seller identifier of the seller.

6. The computer-implemented method of claim 1, wherein executing the process of transferring the ownership at the ownership database further comprises:
forwarding the request to change the ownership, wherein the request comprises the buyer identifier and the object identifier; and
receiving a confirmation from a seller that the ownership can be changed, the confirmation comprising the buyer identifier associated with the object identifier, whereby the buyer identifier is subsequently recorded as the new owner identifier.

7. The computer-implemented method of claim 1, further comprising:
at the computerized transaction system and upon triggering the transaction protocol, listing the respective one of the physical objects for sale;
receiving, from the buyer, a purchase order for the respective one of the physical objects; and
communicating with a seller the object identifier as well as data for shipping the respective one of the physical objects to the buyer.

8. The computer-implemented method of claim 1, wherein the ownership database is further in data communication with a verification database, wherein the verification database stores pairs of the object identifiers and digital fingerprints of the respective ones of physical objects, and wherein, making the request to change the ownership, the buyer has obtained a confirmation from the verification database of genuineness of the respective one of the physical objects based on a digital fingerprint derived from a physical fingerprint of the respective one of the physical objects.

9. The computer-implemented method of claim 8, wherein, after the buyer has received the respective one of the physical objects, the genuineness of the respective one of the physical objects is verified, with a computerized device, by:
obtaining the digital fingerprint, whereby the digital fingerprint is impacted by a unique physical property of the respective one of the physical objects; and
interacting with the verification database by sending a request comprising the object identifier and the digital fingerprint.

10. The computer-implemented method of claim 9, wherein the respective one of the physical objects comprises a physical anchor having the unique physical property, whereby the digital fingerprint is obtained from the physical anchor, so as to be impacted by the unique physical property of the physical anchor of the respective one of the physical objects.

11. The computer-implemented method of claim 9, wherein verifying the genuineness with the computerized device further comprises:
detecting the object identifier and the digital fingerprint, so as to obtain both the object identifier and the digital fingerprint.

12. The computer-implemented method of claim 10, further comprising, at the verification database:
receiving from the buyer a request to confirm the genuineness, wherein the request is based on the object identifier and the digital fingerprint detected by the buyer; and
verifying whether the object identifier and the digital fingerprint match one of the pairs of pairs of the object identifiers and the digital fingerprints stored on the verification database.

13. The computer-implemented method of claim 9, further comprising a set of preparatory steps prior to triggering the transaction protocol:
associating the physical objects with the respective ones of the object identifiers;
obtaining the digital fingerprints from respective ones of physical fingerprints of the physical objects, the physical fingerprints capturing unique physical properties of the respective ones of the physical objects, whereby the digital fingerprints obtained are impacted by respective ones of the unique physical properties;
on the ownership database, storing the object identifiers and the owner identifiers, so as for the owner identifiers to be associated with the respective ones of the object identifiers in the ownership database; and
on the verification database, storing the object identifiers and the digital fingerprints, so as for the digital fingerprints to be associated with the respective ones of the object identifiers.

14. The computer-implemented method of claim 13, wherein the preparatory steps are performed as part of a commissioning of the physical objects.

15. The computer-implemented method of claim 14, wherein preparatory steps further comprise:
pairing physical anchors embodying the respective ones of the physical fingerprints and thus having the unique physical properties with the respective ones of the physical objects, whereby the physical fingerprints are obtained from respective ones of the physical anchors.

16. The computer-implemented method of claim 14, wherein the preparatory steps are performed using a computerized system of a manufacturer of the physical objects, and wherein the ownership database is an external database in data communication with the computerized system of the manufacturer.

17. The computer-implemented method of claim 1, wherein at lease one of the ownership database and a verification database is supported by a distributed system and is configured as a shared ledger.

18. A computer system for managing ownership of physical objects based on identifiers, the computer system comprising:
a communication interface for communicating with a computerized transaction system;
one or more computer readable tangible storage devices storing pairs of object identifiers and owner identifiers, the owner identifiers identifying current owners of respective ones of physical objects corresponding to respective ones of the object identifiers; and
program instructions stored on at least one of the one or more computer readable tangible storage devices for execution by at least one of one or more processors, the program instructions executable to:
upon the computerized transaction system triggering a transaction protocol for a transaction for a respective one of the physical objects, execute, independently of the computerized transaction system, a process of transferring an ownership of the respective one of the physical objects; and
in response to receiving a request to change the ownership from a buyer, record a buyer identifier of the buyer as a new owner identifier associated with an object identifier of the respective one of the physical objects.

19. The computer system of claim 18, wherein the computer system is a distributed system implementing an ownership database as a shared ledger.

20. A computer program product for managing ownership of physical objects based on identifiers, the computer program product comprising one or more computer-readable tangible storage devices and program instructions stored on at least one of the one or more computer-readable tangible storage devices of a computer system, the program instructions executable to:
upon a computerized transaction system triggering a transaction protocol for a transaction for a respective one of the physical objects, execute, independently of the computerized transaction system, a process of transferring an ownership of the respective one of the physical objects;
in response to receiving a request to change the ownership from a buyer, record a buyer identifier of the buyer as a new owner identifier associated with an object identifier of the respective one of the physical objects;
wherein the computer system supports an ownership database and the ownership database stores pairs of object identifiers and owner identifiers and the owner identifiers identify current owners of respective ones of physical objects corresponding to respective ones of the object identifiers; and
wherein the computer system comprises a communication interface for communicating with the computerized transaction system.
